(19) United States
(12) Patent Application Publication
(10) Pub. No.: US 2025/0273398 A1
(43) Pub. Date: Aug. 28, 2025

(54) ELECTRONIC COMPONENT

(71) Applicant: TDK Corporation, Tokyo (JP)

(72) Inventors: Masato KIMURA, Tokyo (JP); Yasuhiro OKUI, Tokyo (JP); Yoshitaka NAGASHIMA, Tokyo (JP); Shinya SAITO, Tokyo (JP); Anna HASHIMOTO, Tokyo (JP); Hotaka WATANABE, Tokyo (JP); Atsushi WATANABE, Tokyo (JP)

(73) Assignee: TDK Corporation, Tokyo (JP)

(21) Appl. No.: 19/045,882

(22) Filed: Feb. 5, 2025

(30) Foreign Application Priority Data
Feb. 27, 2024 (JP) 2024-027529

(51) Int. Cl. H01G 4/232; H01G 4/012; H01G 4/30; H01G 4/38

(52) U.S. Cl. CPC H01G 4/232; H01G 4/012; H01G 4/38; H01G 4/30

(57) ABSTRACT

An electronic component includes: an element body; a first terminal electrode; a second terminal electrode; a first external connection conductor; a second external connection conductor; a first internal electrode; a second internal electrode; a third internal electrode; a fourth internal electrode; and a sixth internal electrode. A first capacitor portion formed by the first internal electrode and the third internal electrode facing each other and a second capacitor portion formed by the second internal electrode and the sixth internal electrode facing each other are connected in series through the first external connection conductor. A third capacitor portion formed by the first internal electrode and the fifth internal electrode facing each other and a fourth capacitor portion formed by the second internal electrode and the fourth internal electrode facing each other are connected in series through the second external connection conductor.

### CROSS-REFERENCE TO RELATED APPLICATIONS

This application is based upon and claims the benefit of priority from Japanese Patent Application No. 2024-027529, filed on Feb. 27, 2024, the entire contents of which are incorporated herein by reference.

### TECHNICAL FIELD

The present disclosure relates to an electronic component.

### BACKGROUND

As a conventional electronic component, one described in Japanese Unexamined Patent Publication No. 2019-46876 is known. The electronic component includes an element body and a pair of terminal electrodes. Inside the element body, internal electrodes are formed so as to form two sets of capacitor portions. In the element body, a first internal electrode and a second internal electrode spaced apart from each other and a third internal electrode facing these internal electrodes are formed.

### SUMMARY

Here, there has been a demand for improving the performance of an electronic component having a plurality of capacitor portions connected in series inside the element body.

The present disclosure has been made to solve such a problem, and it is an object of the present disclosure to provide an electronic component which has a plurality of series-connected capacitor portions and whose performance can be improved.

An electronic component according to the present disclosure includes: an element body having a first main surface and a second main surface facing each other in a first direction, a first end surface and a second end surface facing each other in a second direction perpendicular to the first direction, and a first side surface and a second side surface facing each other in a third direction perpendicular to the first and second directions; a first terminal electrode formed on the first end surface; a second terminal electrode formed on the second end surface; a first external connection conductor formed on the first side surface; a second external connection conductor formed on the second side surface and separated from the first external connection conductor; a first internal electrode provided in the element body and connected to the first terminal electrode at the first end surface; a second internal electrode provided in the element body, separated from the first internal electrode, and connected to the second terminal electrode at the second end surface; a third internal electrode provided in the element body, facing the first internal electrode in the first direction, and connected to the first external connection conductor at the first side surface; a fourth internal electrode provided in the element body, facing the second internal electrode in the first direction, separated from the third internal electrode, and connected to the second external connection conductor at the second side surface; a fifth internal electrode provided in the element body, facing the first internal electrode in the first direction, and connected to the second external connection conductor at the second side surface; and a sixth internal electrode provided in the element body, facing the second internal electrode in the first direction, separated from the fifth internal electrode, and connected to the first external connection conductor at the first side surface. A first capacitor portion formed by the first internal electrode and the third internal electrode facing each other and a second capacitor portion formed by the second internal electrode and the sixth internal electrode facing each other are connected in series through the first external connection conductor. A third capacitor portion formed by the first internal electrode and the fifth internal electrode facing each other and a fourth capacitor portion formed by the second internal electrode and the fourth internal electrode facing each other are connected in series through the second external connection conductor.

In this electronic component, the first internal electrode connected to the first terminal electrode faces the third internal electrode and the fifth internal electrode, and the second internal electrode connected to the second terminal electrode faces the fourth internal electrode and the sixth internal electrode. Here, the third internal electrode and the sixth internal electrode are electrically connected to each other through the first external connection conductor formed on the first side surface. The fourth internal electrode and the fifth internal electrode are electrically connected to each other through the second external connection conductor formed on the second side surface. With such a configuration, the first capacitor portion formed by the first internal electrode and the third internal electrode facing each other and the second capacitor portion formed by the second internal electrode and the sixth internal electrode facing each other are connected in series through the first external connection conductor. In addition, the third capacitor portion formed by the first internal electrode and the fifth internal electrode facing each other and the fourth capacitor portion formed by the second internal electrode and the fourth internal electrode facing each other are connected in series through the second external connection conductor. Therefore, it is possible to improve the reliability. In addition, by using the terminal electrodes and the external connection conductors, it is possible to measure and inspect the presence or absence of short-circuit failure in each capacitor portion. In addition, the second internal electrode is separated from the first internal electrode, the fourth internal electrode is separated from the third internal electrode, and the sixth internal electrode is separated from the fifth internal electrode. That is, between one capacitor portion and the other capacitor portion in the second direction, there is no connection portion for connecting their internal electrodes to each other. For this reason, it is possible to suppress the occurrence of a situation in which a crack generated in one capacitor portion reaches the other capacitor portion along the connection portion. As a result, it is possible to suppress the occurrence of a situation in which the crack reaches both the capacitor portions to cause short-circuiting. As described above, it is possible to improve the performance of an electronic component having a plurality of capacitor portions connected in series to each other.

The first internal electrode and the second internal electrode may be arranged in outermost layers of stacked internal electrodes. In this case, the internal electrode closest to the first terminal electrode on each main surface is the first internal electrode having the same polarity as the first terminal electrode, and the internal electrode closest to the second terminal electrode is the second internal electrode having the same polarity as the second terminal electrode. Therefore, it is possible to suppress surface leakage between the inner electrode of the outermost layer and the terminal electrode having an opposite polarity.

The element body may have a gap portion in which no internal electrode is formed when viewed from the first direction. In this case, it is possible to suppress the progress of a crack generated in one capacitor portion to the other capacitor portion.

A width of the gap portion in the second direction may be equal to or greater than an interlayer thickness of the element body. In this case, in the gap portion, it is possible to secure pressure resistance higher than the voltage breakdown between the layers.

The first terminal electrode and the second terminal electrode may include a conductive resin layer. In this case, the reliability of the electronic component can be improved by reducing the influence of the stress caused by the bending of the mounting board.

An edge portion of the third internal electrode and an edge portion of the fourth internal electrode facing each other in the second direction and an edge portion of the fifth internal electrode and an edge portion of the sixth internal electrode facing each other in the second direction may be bent in an L shape or inclined with respect to the third direction. In this case, the lengths of the first external connection conductor and the second external connection conductor in the second direction can be reduced. In this case, it is possible to reduce the risk of short-circuiting due to the first terminal electrode or the second terminal electrode and the first external connection conductor or the second external connection conductor being electrically connected to each other by solder during mounting on the board.

Assuming that a layer having the first internal electrode and the second internal electrode is a first electrode layer, a layer having the third internal electrode and the fourth internal electrode is a second electrode layer, and a layer having the fifth internal electrode and the sixth internal electrode is a third electrode layer, a plurality of the first electrode layers, a plurality of the second electrode layers, and a plurality of the third electrode layers may be stacked in the element body, and the second electrode layer and the third electrode layer may be stacked alternately with the first electrode layer interposed between the second electrode layer and the third electrode layer. In this case, it is possible to reduce the possibility that the ESL will increase.

Assuming that a layer having the first internal electrode and the second internal electrode is a first electrode layer, a layer having the third internal electrode and the fourth internal electrode is a second electrode layer, and a layer having the fifth internal electrode and the sixth internal electrode is a third electrode layer, a plurality of the first electrode layers, a plurality of the second electrode layers, and a plurality of the third electrode layers may be stacked in the element body, the plurality of second electrode layers may be stacked on one main surface side of the first main surface and the second main surface with the first electrode layer interposed between the plurality of second electrode layers, and the plurality of third electrode layers may be stacked on the other main surface side of the first main surface and the second main surface with the first electrode layer interposed between the plurality of third electrode layers. In this case, it is possible to suppress an increase in the risk of failure in a lead-out portion connecting the third and sixth internal electrodes to the first external connection conductor and a lead-out portion connecting the fourth and fifth internal electrodes to the second external connection conductor.

An electronic component according to the present disclosure includes: an element body having a first main surface and a second main surface facing each other in a first direction, a first end surface and a second end surface facing each other in a second direction perpendicular to the first direction, and a first side surface and a second side surface facing each other in a third direction perpendicular to the first and second directions; a first terminal electrode formed on the first end surface; a second terminal electrode formed on the second end surface; a first external connection conductor formed on the first side surface; a second external connection conductor formed on the second side surface and separated from the first external connection conductor; a first internal electrode provided in the element body and connected to the first terminal electrode at the first end surface; a second internal electrode provided in the element body, separated from the first internal electrode, and connected to the second terminal electrode at the second end surface; a third internal electrode provided in the element body, facing the first internal electrode in the first direction, and connected to the first external connection conductor at the first side surface; a fourth internal electrode provided in the element body, facing the second internal electrode in the first direction, separated from the third internal electrode, and connected to the second external connection conductor at the second side surface; a seventh internal electrode provided in the element body, arranged between the first internal electrode and the second internal electrode in the second direction, separated from the first internal electrode and the second internal electrode, and connected to the first external connection conductor at the first side surface; and an eighth internal electrode provided in the element body, arranged between the third internal electrode and the fourth internal electrode in the second direction, separated from the third internal electrode and the fourth internal electrode, and connected to the second external connection conductor at the second side surface. A first capacitor portion formed by the first internal electrode and the third internal electrode facing each other and a seventh capacitor portion formed by the seventh internal electrode and the eighth internal electrode facing each other are connected in series through the first external connection conductor. A fifth capacitor portion formed by the seventh internal electrode and the eighth internal electrode facing each other and a fourth capacitor portion formed by the second internal electrode and the fourth internal electrode facing each other are connected in series through a second external connection conductor.

In this electronic component, the first internal electrode connected to the first terminal electrode faces the third internal electrode, the second internal electrode connected to the second terminal electrode faces the fourth internal electrode, and the seventh internal electrode faces the eighth internal electrode. Here, the third internal electrode and the seventh internal electrode are electrically connected to each other through the first external connection conductor formed on the first side surface. In addition, the fourth internal electrode and the eighth internal electrode are electrically connected to each other through the second external connection conductor formed on the second side surface. With such a configuration, the first capacitor portion formed by the first internal electrode and the third internal electrode, the fifth capacitor portion formed by the seventh internal electrode and the eighth internal electrode, and the fourth capacitor portion formed by the second internal electrode and the fourth internal electrode are connected in series through the first external connection conductor and the second external connection conductor, so that it is possible to improve the reliability. In addition, the seventh internal electrode is separated from the first internal electrode and the second internal electrode. The eighth internal electrode is separated from the third internal electrode and the fourth internal electrode. That is, between one capacitor portion and the other capacitor portion adjacent to each other, there is no connection portion for connecting their internal electrodes to each other. For this reason, it is possible to suppress the occurrence of a situation in which a crack generated in one capacitor portion reaches the other capacitor portion along the connection portion. As a result, it is possible to suppress the occurrence of a situation in which the crack reaches both the capacitor portions adjacent to each other to cause short-circuiting. As described above, it is possible to improve the performance of an electronic component having a plurality of capacitor portions connected in series to each other.

According to the present disclosure, it is possible to provide an electronic component which has a plurality of series-connected capacitor portions and whose performance can be improved.

### BRIEF DESCRIPTION OF THE DRAWINGS

FIG. 1A is a plan view of an electronic component according to the present embodiment, and FIG. 1B is a front view of the electronic component according to the present embodiment.

FIG. 2A is a cross-sectional view taken along the line IIa-IIa shown in FIG. 1A, and FIG. 2B is a cross-sectional view taken along the line IIb-IIb shown in FIG. 1B.

FIG. 3A is a drawing showing a first internal electrode and a second internal electrode, FIG. 3B is a drawing showing a third internal electrode and a fourth internal electrode, and FIG. 3C is a drawing showing a fifth internal electrode and a sixth internal electrode.

FIG. 4A is a drawing showing how the first internal electrode and the second internal electrode overlap the third internal electrode and the fourth internal electrode, FIG. 4B is a drawing showing how the first internal electrode and the second internal electrode overlap the fifth internal electrode and the sixth internal electrode, and FIG. 4C is a drawing showing the overlapping of all the internal electrodes.

FIGS. 5A and 5B are drawings showing an example of a stacking order of electrode layers.

FIGS. 6A and 6B are drawings showing a circuit structure formed by a stacked structure of an element body.

FIG. 7A is a cross-sectional view showing an electronic component according to an embodiment, and FIG. 7B is a cross-sectional view showing an electronic component according to a comparative example.

FIGS. 8A and 8B are cross-sectional views showing an electronic component according to an embodiment, and FIGS. 8C and 8D are cross-sectional views showing an electronic component according to a comparative example.

FIGS. 9A, 9B, and 9C are drawings showing an electronic component according to a modification example.

FIGS. 10A, 10B, and 10C are drawings showing an electronic component according to a modification example.

FIG. 11 is a drawing showing an electronic component according to a modification example.

FIGS. 12A and 12B are drawings showing internal electrodes of an electronic component according to a modification example.

FIG. 13 is a drawing showing an example of a stacking order of an electronic component according to a modification example.

### DETAILED DESCRIPTION

Hereinafter, embodiments of the present disclosure will be described in detail with reference to the accompanying drawings. In addition, in the description, the same elements or elements having the same functions are denoted by the same reference numerals, and repeated descriptions thereof will be omitted.

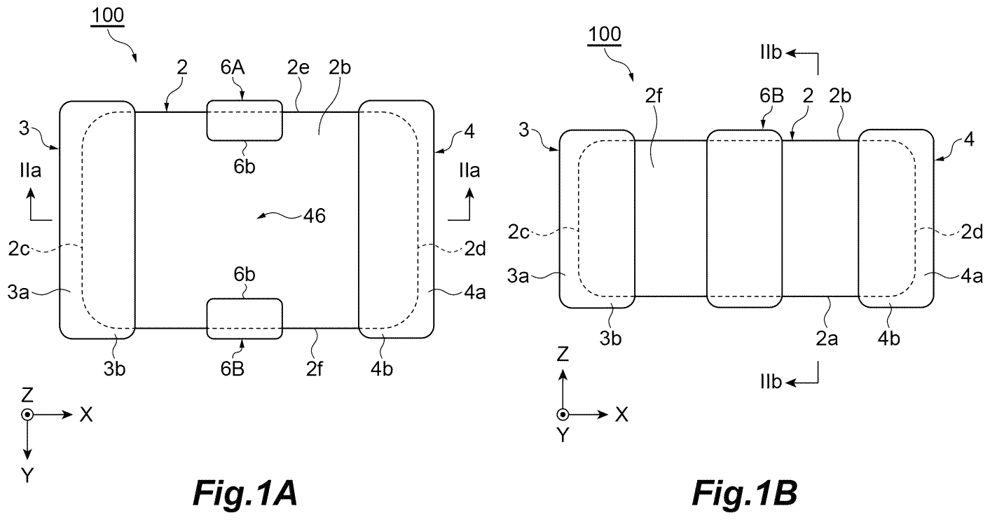

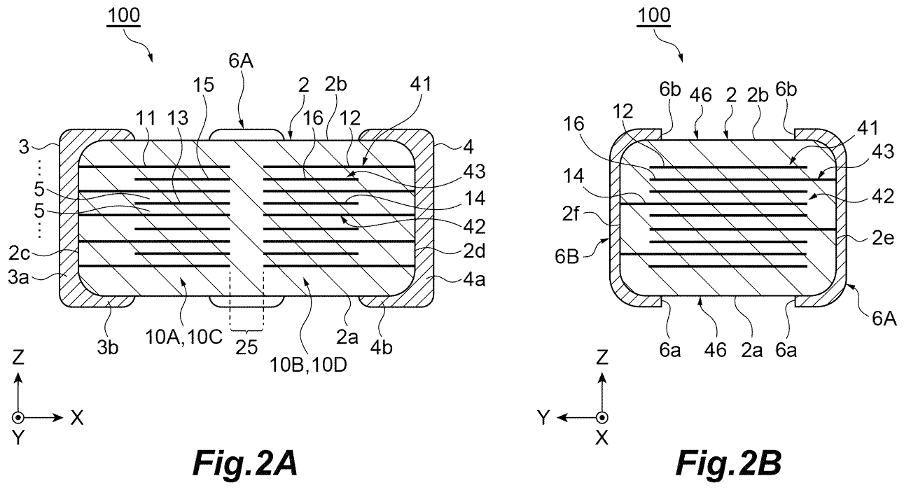

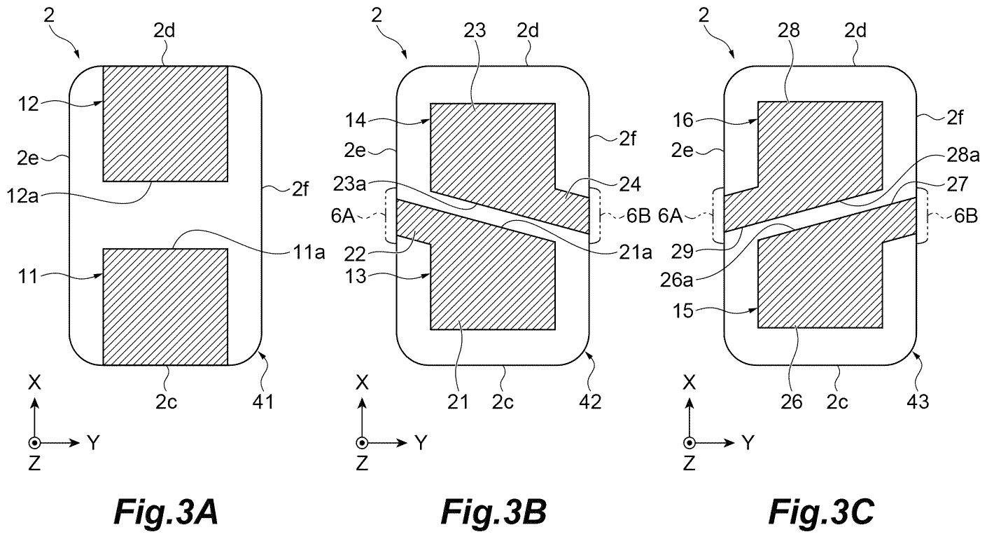

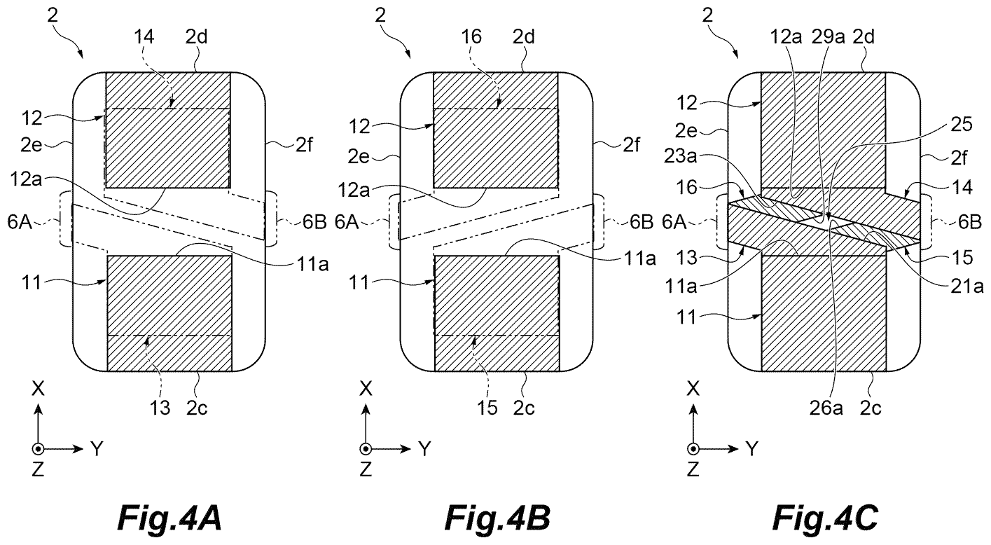

First, the configuration of an electronic component 100 according to the present embodiment will be described with reference to FIGS. 1 to 4. FIG. 1A is a plan view of the electronic component according to the present embodiment, and FIG. 1B is a front view of the electronic component according to the present embodiment. FIG. 2A is a cross-sectional view taken along the line IIa-IIa shown in FIG. 1A, and FIG. 2B is a cross-sectional view taken along the line IIb-IIb shown in FIG. 1B. FIG. 3A is a drawing showing a first internal electrode and a second internal electrode, FIG. 3B is a drawing showing a third internal electrode and a fourth internal electrode, and FIG. 3C is a drawing showing a fifth internal electrode and a sixth internal electrode. FIG. 4A is a drawing showing how the first internal electrode and the second internal electrode overlap the third internal electrode and the fourth internal electrode. FIG. 4B is a drawing showing how the first internal electrode and the second internal electrode overlap the fifth internal electrode and the sixth internal electrode. In FIGS. 4A and 4B, the third internal electrode, the fourth internal electrode, the fifth internal electrode, and the sixth internal electrode are indicated by virtual lines. FIG. 4C is a drawing showing a state in which all the internal electrodes overlap each other.

In addition, in the following description, an XYZ coordinate system may be set for the electronic component 100 for explanation. The Z-axis direction (first direction) is a stacking direction in which internal electrodes, which will be described later, are stacked. The Z-axis direction is a direction perpendicular to the surface of a circuit board on which components are mounted during mounting. The X-axis direction (second direction) is a direction perpendicular to the Z-axis direction, and is a direction parallel to the surface of the circuit board during mounting. In addition, the X-axis direction corresponds to a longitudinal direction in which an element body 2 extends. The Y-axis direction (third direction) is a direction perpendicular to the Z-axis direction and the X-axis direction, and is a direction parallel to the surface of the circuit board during mounting and perpendicular to the X-axis direction. In FIGS. 1A and 1B, the upper side is a positive side in the Z-axis direction, and the lower side is a negative side in the Z-axis direction.

As shown in FIGS. 1A and 1B, the electronic component 100 includes the element body 2, a first terminal electrode 3, a second terminal electrode 4, and first and second external connection conductors 6A and 6B. As shown in FIGS. 2A and 2B, the electronic component 100 includes a first internal electrode 11, a second internal electrode 12, a third internal electrode 13, a fourth internal electrode 14, a fifth internal electrode 15, and a sixth internal electrode 16 inside the element body 2.

As shown in FIGS. 1A and 1B, the element body 2 is a rectangular parallelepiped component extending along the X-axis direction that is the longitudinal direction. The element body 2 has a first main surface 2a and a second main surface 2b facing each other in the Z-axis direction, a first end surface 2c and a second end surface 2d facing each other in the X-axis direction, and a first side surface 2e and a second side surface 2f facing each other in the Y-axis direction. The first main surface 2a is arranged on the negative side in the Z-axis direction, and the second main surface 2b is arranged on the positive side in the Z-axis direction. The first end surface 2c is arranged on the negative side in the X-axis direction, and the second end surface 2d is arranged on the positive side in the X-axis direction. The first side surface 2e is arranged on the negative side in the Y-axis direction, and the second side surface 2f is arranged on the positive side in the Y-axis direction. Among these, the first main surface 2a is a mounting surface facing a mounting board during mounting.

The shape of the element body 2 is not particularly limited, but has a rectangular parallelepiped shape in which the size in the X-axis direction is larger than the sizes in the Z-axis direction and the Y-axis direction. Examples of the rectangular parallelepiped shape include a rectangular parallelepiped shape with chamfered corners and ridges and a rectangular parallelepiped shape with rounded corners and ridges. For example, the length of the element body 2 in the X-axis direction may be 0.5 to 7.7 mm, the length of the element body 2 in the Y-axis direction may be 0.29 to 4.7 mm, and the length of the element body 2 in the Z-axis direction may be 0.29 to 4.0 mm.

The element body 2 is formed by stacking a plurality of dielectric layers (dielectric layers 5 shown in FIG. 2A) in the Z-axis direction. Each dielectric layer is configured as, for example, a sintered body of a ceramic green sheet containing a dielectric material (BaTiO₃-based dielectric ceramic, Ba(Ti, Zr)O₃-based dielectric ceramic, (Ba, Ca)TiO₃-based dielectric ceramic, and the like). In the actual element body 2, the respective dielectric layers 5 are integrated to such an extent that the boundary between each of the dielectric layers 5 cannot be visually recognized.

The terminal electrodes 3 and 4 are provided so as to cover the end surfaces 2c and 2d of the element body 2. The terminal electrodes 3 and 4 are portions for electrically connecting electronic component 100 to other members. The terminal electrodes 3 and 4 have main body portions 3a and 4a and wrap-around portions 3b and 4b, respectively. The main body portions 3a and 4a are formed on the end surfaces 2c and 2d of the element body 2, respectively. The main body portions 3a and 4a are formed so as to cover the entire surfaces of the end surfaces 2c and 2d, respectively. The wrap-around portions 3b and 4b are formed so as to wrap around the main surfaces 2a and 2b and the side surfaces 2e and 2f from the main body portions 3a and 4a. The wrap-around portion 3b is formed so as to cover parts of the main surfaces 2a and 2b and the side surfaces 2e and 2f near the first end surface 2c. The wrap-around portion 4b is formed so as to cover parts of the main surfaces 2a and 2b and the side surfaces 2e and 2f near the second end surface 2d.

The first external connection conductor 6A is a conductor for connecting the third internal electrode 13 and the sixth internal electrode 16 to each other outside the element body 2. The second external connection conductor 6B is a conductor for connecting the fourth internal electrode 14 and the fifth internal electrode 15 to each other outside the element body 2. The first and second external connection conductors 6A and 6B are formed at an approximately central position in the X-axis direction in the element body 2. The first and second external connection conductors 6A and 6B are formed so as to be spaced apart from the terminal electrodes 3 and 4 in the X-axis direction. The first external connection conductor 6A is formed on the side surface 2e. The first external connection conductor 6A extends over the entire length of the side surface 2e in the Z-axis direction. The first external connection conductor 6A wraps around the main surfaces 2a and 2b. The second external connection conductor 6B is formed on the side surface 2f. The second external connection conductor 6B extends over the entire length of the side surface 2f in the Z-axis direction. The second external connection conductor 6B wraps around the main surfaces 2a and 2b. Ends 6a and 6a of the first and second external connection conductors 6A and 6B on the main surface 2a are spaced apart from each other in the Y-axis direction. The ends 6b and 6b of the first and second external connection conductors 6A and 6B on the main surface 2b are spaced apart from each other in the Y-axis direction. Therefore, regions near the central positions of the first and second main surfaces 2a and 2b are exposed to the first and second external connection conductors 6A and 6B. In addition, with such a configuration, the first and second external connection conductors 6A and 6B are mechanically separated from each other.

Materials for the terminal electrodes 3 and 4 and the external connection conductor 6 are not particularly limited, but may contain copper. In addition, the terminal electrodes 3 and 4 and the first and second external connection conductors 6A and 6B may be copper baking layers, and an Ni plating layer, an Sn plating layer, and the like may be formed on these baking layers. In addition, the terminal electrodes 3 and 4 may include a conductive resin layer formed of a material such as silver.

As shown in FIG. 2, the internal electrodes 11, 12, 13, 14, 15, and 16 are flat conductor patterns extending in parallel to the XY plane. A plurality of internal electrodes 11, 12, 13, 14, 15, and 16 are formed in the Z-axis direction. The first internal electrode 11 is provided in a region on the negative side in the X-axis direction inside the element body 2, and is connected to the first terminal electrode 3 at the first end surface 2c. The second internal electrode 12 is provided in a region on the positive side in the X-axis direction inside the element body 2, and is connected to the second terminal electrode 4 at the second end surface 2d. The first internal electrode 11 and the second internal electrode 12 are arranged within the same plane. That is, the first internal electrode 11 and the second internal electrode 12 are formed on the same dielectric layer 5, and accordingly their positions in the Z-axis direction are the same. Before stacking, conductor patterns of the first internal electrode 11 and the second internal electrode 12 are formed on the ceramic green sheet of the dielectric layer 5. The first internal electrode 11 and the second internal electrode 12 are mechanically (physically, structurally) separated (spaced apart) from each other. In addition, a layer having the first internal electrode 11 and the second internal electrode 12 may be referred to as a first electrode layer 41. When the internal electrodes are separated from each other, the material of the dielectric layer 5 is present in the entire area between one internal electrode and the other internal electrode.

The third internal electrode 13 is provided in a region on the negative side in the X-axis direction inside the element body 2, and is drawn out to the first side surface 2e (see FIG. 3B). The fourth internal electrode 14 is provided in a region on the positive side in the X-axis direction inside the element body 2, and is drawn out to the second side surface 2f (see FIG. 3B). The third internal electrode 13 and the fourth internal electrode 14 are arranged within the same plane. That is, the third internal electrode 13 and the fourth internal electrode 14 are formed on the same dielectric layer 5, and accordingly their positions in the Z-axis direction are the same. Before stacking, conductor patterns of the third internal electrode 13 and the fourth internal electrode 14 are formed on the ceramic green sheet of the dielectric layer 5. The third internal electrode 13 and the fourth internal electrode 14 are mechanically separated from each other. In addition, a layer having the third internal electrode 13 and the fourth internal electrode 14 may be referred to as a second electrode layer 42. The fifth internal electrode 15 is provided in a region on the negative side in the X-axis direction inside the element body 2, and is drawn out to the second side surface 2f (see FIG. 3C). The sixth internal electrode 16 is provided in a region on the positive side in the X-axis direction inside the element body 2, and is drawn out to the first side surface 2e (see FIG. 3C). The fifth internal electrode 15 and the sixth internal electrode 16 are arranged within the same plane. That is, the fifth internal electrode 15 and the sixth internal electrode 16 are formed on the same dielectric layer 5, and accordingly their positions in the Z-axis direction are the same. Before stacking, conductor patterns of the fifth internal electrode 15 and the sixth internal electrode 16 are formed on the ceramic green sheet of the dielectric layer 5. The fifth internal electrode 15 and the sixth internal electrode 16 are mechanically separated from each other. In addition, a layer having the fifth internal electrode 15 and the sixth internal electrode 16 may be referred to as a third electrode layer 43.

As shown in FIGS. 3A to 3C, in the Z-axis direction, the first internal electrode 11 faces the third internal electrode 13 and the fifth internal electrode 15 without facing the second internal electrode 12, the fourth internal electrode 14, and the sixth internal electrode 16. In the Z-axis direction, the second internal electrode 12 faces the fourth internal electrode 14 and the sixth internal electrode 16 without facing the first internal electrode 11, the third internal electrode 13, and the fifth internal electrode 15. The first internal electrode 11, the third internal electrode 13, and the fifth internal electrode 15 are arranged so as to be spaced apart from the second internal electrode 12, the fourth internal electrode 14, and the sixth internal electrode 16 in the X-axis direction.

An example of a specific shape of each of the internal electrodes 11, 12, 13, 14, 15, and 16 will be described with reference to FIGS. 3A to 3C. As shown in FIG. 3A, the first internal electrode 11 extends from the first end surface 2c to the positive side in the X-axis direction through the central position of the element body 2. An edge portion 11a of the first internal electrode 11 on the inner side in the X-axis direction (positive side in the X-axis direction) extends in parallel to the Y-axis direction. An edge portion of the first internal electrode 11 on the negative side in the X-axis direction is exposed from the first end surface 2c and connected to the first terminal electrode 3. The edge portion of the first internal electrode 11 on the negative side in the Y-axis direction is spaced apart from and parallel to the first side surface 2e. The edge portion of the first internal electrode 11 on the positive side in the Y-axis direction is spaced apart from and parallel to the second side surface 2f.

The second internal electrode 12 extends from the second end surface 2d to the negative side in the X-axis direction through the central position of the element body 2. An edge portion 12a of the second internal electrode 12 on the inner side in the X-axis direction (negative side in the X-axis direction) extends in parallel to the Y-axis direction. The edge portion 12a of the second internal electrode 12 is parallel to the edge portion 11a of the first internal electrode 11 while being spaced apart from each other in the X-axis direction. An edge portion of the second internal electrode 12 on the positive side in the X-axis direction is exposed from the second end surface 2d and connected to the second terminal electrode 4. The edge portion of the second internal electrode 12 on the negative side in the Y-axis direction is spaced apart from and parallel to the first side surface 2e. The edge portion of the second internal electrode 12 on the positive side in the Y-axis direction is spaced apart from and parallel to the second side surface 2f. The edge portions of the second internal electrode 12 on both sides in the Y-axis direction are arranged at the same positions in the Y-axis direction as the edge portions of the first internal electrode 11 on both sides in the Y-axis direction.

As shown in FIG. 3B, the third internal electrode 13 has a main body portion 21 and a lead-out portion 22. The main body portion 21 is a portion arranged so as to overlap the first internal electrode 11 (see FIG. 4A). Therefore, an edge portion 21a of the main body portion 21 on the positive side in the X-axis direction is inclined so as to be toward the negative side in the X-axis direction as moving from the negative side to the positive side in the Y-axis direction. An edge portion of the main body portion 21 on the negative side in the X-axis direction is spaced apart from the first end surface 2c toward the positive side in the X-axis direction. The edge portions of the main body portion 21 on both sides in the Y-axis direction have the same shapes as the edge portions of the first internal electrode 11 on both sides in the Y-axis direction, and are arranged at the same positions (see FIG. 4A). The lead-out portion 22 is connected to the first external connection conductor 6A by extending from the main body portion 21 toward the negative side in the Y-axis direction and being exposed on the first side surface 2e. The lead-out portion 22 extends toward the negative side in the Y-axis direction while being inclined so as to continue from the edge portion 21a of the main body portion 21.

The fourth internal electrode 14 includes a main body portion 23 and a lead-out portion 24. The main body portion 23 is a portion arranged so as to overlap the second internal electrode 12 (see FIG. 4A). Therefore, an edge portion 23a of the main body portion 23 on the negative side in the X-axis direction is inclined so as to be toward the negative side in the X-axis direction as moving from the negative side to the positive side in the Y-axis direction. An edge portion of the main body portion 23 on the positive side in the X-axis direction is spaced apart from the second end surface 2d toward the negative side in the X-axis direction. The edge portions of the main body portion 23 on both sides in the Y-axis direction have the same shapes as the edge portions of the second internal electrode 12 on both sides in the Y-axis direction, and are arranged at the same positions (see FIG. 4A). The lead-out portion 24 is connected to the second external connection conductor 6B by extending from the main body portion 23 toward the positive side in the Y-axis direction and being exposed on the second side surface 2f. The lead-out portion 24 extends toward the positive side in the Y-axis direction while being inclined so as to continue from the edge portion 23a of the main body portion 23.

As shown in FIG. 3C, the fifth internal electrode 15 has a main body portion 26 and a lead-out portion 27. The main body portion 26 is a portion arranged so as to overlap the first internal electrode 11 (see FIG. 4B). Therefore, an edge portion 26a of the main body portion 26 on the positive side in the X-axis direction is inclined so as to be toward the positive side in the X-axis direction as moving from the negative side to the positive side in the Y-axis direction. An edge portion of the main body portion 26 on the negative side in the X-axis direction is spaced apart from the first end surface 2c toward the positive side in the X-axis direction. The edge portions of the main body portion 26 on both sides in the Y-axis direction have the same shapes as the edge portions of the first internal electrode 11 on both sides in the Y-axis direction, and are arranged at the same positions (see FIG. 4B). The lead-out portion 27 is connected to the second external connection conductor 6B by extending from the main body portion 26 toward the positive side in the Y-axis direction and being exposed on the second side surface 2f. The lead-out portion 27 extends toward the negative side in the Y-axis direction while being inclined so as to continue from the edge portion 26a of the main body portion 26.

The sixth internal electrode 16 includes a main body portion 28 and a lead-out portion 29. The main body portion 28 is a portion arranged so as to overlap the second internal electrode 12 (see FIG. 4B). Therefore, an edge portion 28a of the main body portion 28 on the negative side in the X-axis direction is inclined so as to be toward the positive side in the X-axis direction as moving from the negative side to the positive side in the Y-axis direction. An edge portion of the main body portion 28 on the positive side in the X-axis direction is spaced apart from the second end surface 2d toward the negative side in the X-axis direction. The edge portions of the main body portion 28 on both sides in the Y-axis direction have the same shapes as the edge portions of the second internal electrode 12 on both sides in the Y-axis direction, and are arranged at the same positions (see FIG. 4B). The lead-out portion 29 is connected to the first external connection conductor 6A by extending from the main body portion 28 toward the negative side in the Y-axis direction and being exposed on the first side surface 2e. The lead-out portion 29 extends toward the positive side in the Y-axis direction while being inclined so as to continue from the edge portion 28a of the main body portion 28.

FIGS. 3A to 3C, the first internal electrode 11 does not overlap the internal electrodes 12, 14, and 16 in the Z-axis direction. The second internal electrode 12 does not overlap the internal electrodes 11, 13, and 15 in the Z-axis direction. The internal electrodes 11, 12, 13, 14, 15, and 16 are mechanically separated (spaced apart) from each other.

As shown in FIG. 4C, when viewed from the Z-axis direction, the element body 2 has a gap portion 25 in which the internal electrodes 11, 12, 13, 14, 15, and 16 are not formed. Specifically, the gap portion 25 is formed by combining a gap between the edge portion 11a of the first internal electrode 11 and the edge portion 12a of the second internal electrode 12, a gap between the edge portion 21a of the third internal electrode 13 and the edge portion 23a of the fourth internal electrode 14, and the edge portion 26a of the fifth internal electrode 15 and the edge portion 28a of the sixth internal electrode 16. In addition, the gap portion 25 is formed by a combination of these gaps that are continuous in the Z-axis direction. The width of the gap portion 25 in the X-axis direction is equal to or greater than the interlayer thickness of the element body 2. The width of the gap portion 25 in the X-axis direction is the maximum size of the gap portion 25 in the X-axis direction. The interlayer thickness is the thickness of one dielectric layer 5, and is defined by the thickness between the internal electrodes 11 and 13, the thickness between the internal electrodes 12 and 14, the thickness between the internal electrodes 11 and 15, and the thickness between the internal electrodes 12 and 16. The interlayer thickness is set to about 1 to 50 μm. On the other hand, the width of the gap portion 25 is set to about 1 to 1000 μm.

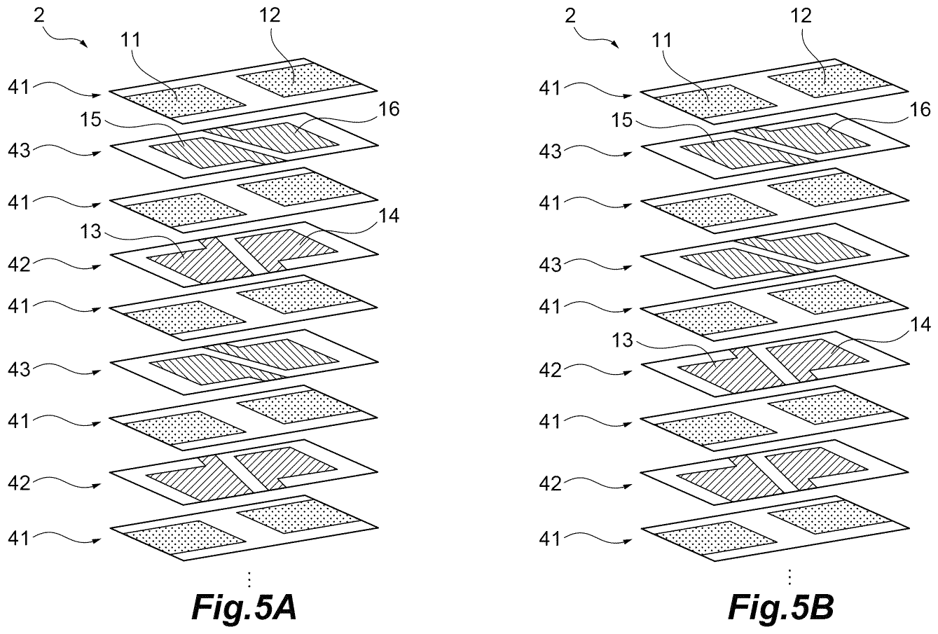

The stacking order of the first electrode layer 41, the second electrode layer 42, and the third electrode layer 43 is not particularly limited. For example, the order shown in FIG. 5 may be adopted. As shown in FIG. 5A, in the element body 2, a plurality of first electrode layers 41, a plurality of second electrode layers 42, and a plurality of third electrode layers 43 are stacked. The second electrode layer 42 and the third electrode layer 43 are alternately stacked with the first electrode layer 41 interposed therebetween. That is, the first electrode layer 41, the second electrode layer 42, the first electrode layer 41, and the third electrode layer 43 are stacked in this order from the bottom, and this stacking order is repeated.

In addition, as shown in FIG. 5B, in the element body 2, a plurality of first electrode layers 41, a plurality of second electrode layers 42, and a plurality of third electrode layers 43 are stacked. A plurality of second electrode layers 42 are stacked on the first main surface 2a side with the first electrode layer 41 interposed therebetween, and a plurality of third electrode layers 43 are stacked on the second main surface 2b side with the first electrode layer 41 interposed therebetween. That is, a plurality of second electrode layers 42 are arranged collectively on the first main surface 2a side (here, the lower side), and a plurality of third electrode layers 43 are arranged collectively on the second main surface 2b side (here, the upper side). The first electrode layer 41 is arranged between the second electrode layer 42 and the second electrode layer 42, between the second electrode layer 42 and the third electrode layer 43, and between the third electrode layer 43 and the third electrode layer 43. Specifically, the first electrode layer 41, the second electrode layer 42, the first electrode layer 41, the second electrode layer 42, the first electrode layer 41, the third electrode layer 43, the first electrode layer 41, the third electrode layer 43, and the first electrode layer 41 are stacked in this order. In addition, a plurality of second electrode layers 42 may be arranged on the second main surface 2b side, and a plurality of third electrode layers 43 may be arranged on the first main surface 2a side.

The first internal electrode 11 and the second internal electrode 12 are arranged in the outermost layers of the stacked internal electrodes. That is, among the internal electrodes arranged inside the element body 2, the first internal electrode 11 and the second internal electrode 12 are arranged on the most positive side in the Z-axis direction, and the first internal electrode 11 and the second internal electrode 12 are arranged on the most negative side in the Z-axis direction.

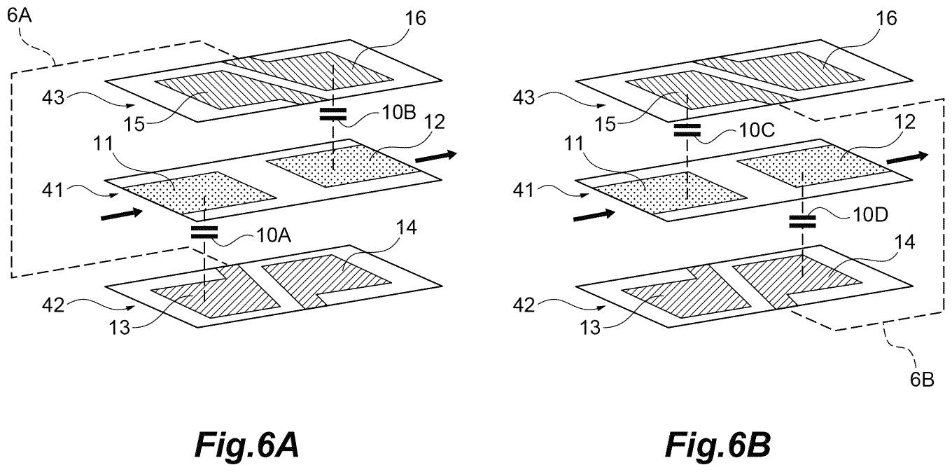

Next, a circuit structure formed by the above stacked structure will be described with reference to FIGS. 6A and 6B. In addition, when the electronic component 100 is mounted on a circuit board, the first terminal electrode 3 and the second terminal electrode 4 are connected to electrodes of the circuit board. On the other hand, since the external connection conductors 6A and 6B are conductors having a function of connecting capacitor portions in the electronic component 100 to each other, the external connection conductors 6A and 6B are not connected to the electrodes of the circuit board. The circuit structure shown in FIGS. 6A and 6B will be described on the assumption that such a mounting mode is used. As shown in FIG. 6A, first, a current flows through the first internal electrode 11. A first capacitor portion 10A is formed between the first internal electrode 11 and the third internal electrode 13. The third internal electrode 13 is connected to the sixth internal electrode 16 through the first external connection conductor 6A. A second capacitor portion 10B is formed between the sixth internal electrode 16 and the second internal electrode 12. As a result of the above, the first capacitor portion 10A formed by the first internal electrode 11 and the third internal electrode 13 facing each other and the second capacitor portion 10B formed by the second internal electrode 12 and the sixth internal electrode 16 facing each other are connected in series through the first external connection conductor 6A.

In addition, as shown in FIG. 6B, first, a current flows through the first internal electrode 11. A third capacitor portion 10C is formed between the first internal electrode 11 and the fifth internal electrode 15. The fifth internal electrode 15 is connected to the fourth internal electrode 14 through the second external connection conductor 6B. A fourth capacitor portion 10D is formed between the fourth internal electrode 14 and the second internal electrode 12. As a result of the above, the third capacitor portion 10C formed by the first internal electrode 11 and the fifth internal electrode 15 facing each other and the fourth capacitor portion 10D formed by the second internal electrode 12 and the fourth internal electrode 14 facing each other are connected in series through the second external connection conductor 6B.

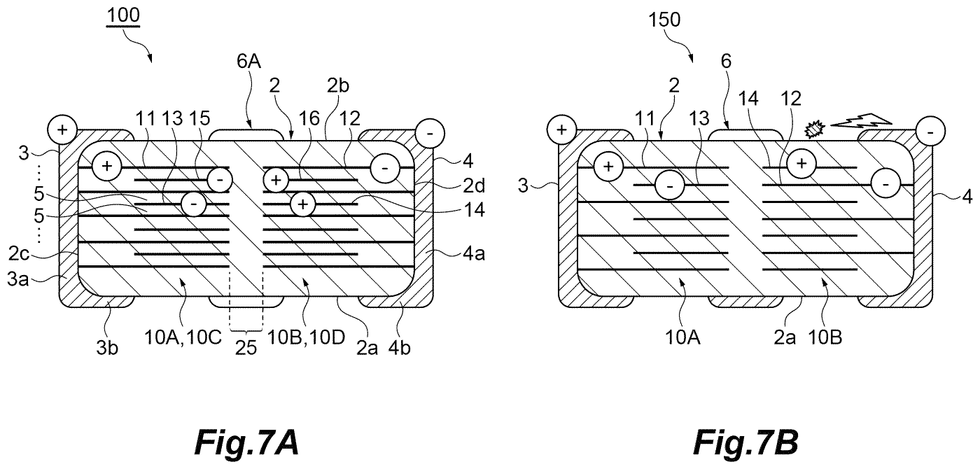

The polarities of the capacitor portions 10A, 10B, 10C, and 10D will be described with reference to FIG. 7A. As shown in FIG. 7A, when the electronic component 100 is mounted, the first terminal electrode 3 has a positive polarity and the second terminal electrode 4 has a negative polarity. Since the third internal electrode 13 and the sixth internal electrode 16 are connected to each other through the first external connection conductor 6A, the third internal electrode 13 and the sixth internal electrode 16 have the same potential. Since the fourth internal electrode 14 and the fifth internal electrode 15 are connected to each other through the second external connection conductor 6B, the fourth internal electrode 14 and the fifth internal electrode 15 have the same potential. At this time, in the capacitor portion 10A, the first internal electrode 11 connected to the first terminal electrode 3 has a positive polarity, and the third internal electrode 13 has a negative polarity. On the other hand, in the capacitor portion 10B, the second internal electrode 12 connected to the second terminal electrode 4 has a negative polarity, and the sixth internal electrode 16 has a positive polarity. In the capacitor portion 10C, the first internal electrode 11 connected to the first terminal electrode 3 has a positive polarity, and the fifth internal electrode 15 has a negative polarity. On the other hand, in the capacitor portion 10D, the second internal electrode 12 connected to the second terminal electrode 4 has a negative polarity, and the fourth internal electrode 14 has a positive polarity. In this manner, the capacitor portion 10A and the capacitor portion 10B are present between the first terminal electrode 3 and the second terminal electrode 4 in a state in which the capacitor portion 10A and the capacitor portion 10B are connected in series to each other. In addition, the capacitor portion 10C and the capacitor portion 10D are present between the first terminal electrode 3 and the second terminal electrode 4 in a state in which the capacitor portion 10C and the capacitor portion 10D are connected in series to each other.

Next, the function and effect of the electronic component 100 according to the present embodiment will be described.

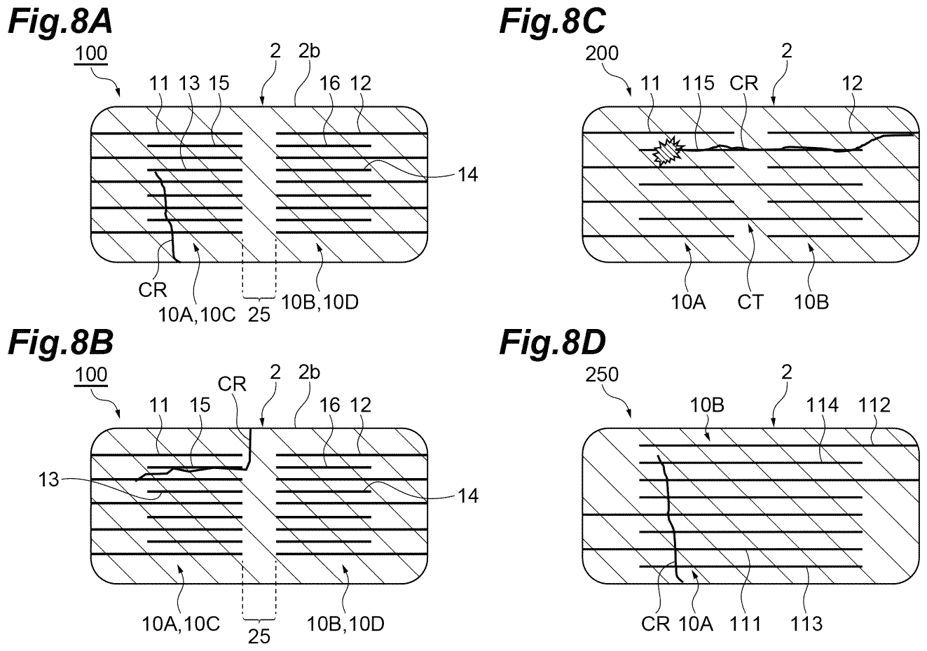

First, an electronic component according to a comparative example will be described. FIG. 8C is a schematic cross-sectional view showing the internal structure of an element body 2 of an electronic component 200 according to a comparative example. The electronic component 200 includes an internal electrode 115 that simultaneously forms the first capacitor portion 10A and the second capacitor portion 10B, instead of the internal electrodes 13, 14, 15, and 16 of the present embodiment. The internal electrode 115 extends so as to face both the first internal electrode 11 and the second internal electrode 12. Therefore, the gap portion 25 is not formed in the element body 2, and the internal electrode 115 has a connection portion CT that connects the first capacitor portion 10A and the second capacitor portion 10B to each other. Since such an electronic component 200 does not have an external connection conductor, when one of the first capacitor portion 10A and the second capacitor portion 10B is short-circuited, the short-circuiting cannot be detected. In addition, when a crack CR occurs in one first capacitor portion 10A, the crack CR may reach the other second capacitor portion 10B along the connection portion CT. In this case, both the capacitor portions 10A and 10B are short-circuited due to the influence of the short-circuiting of one first capacitor portion 10A.

FIG. 8D is a schematic cross-sectional view of an electronic component 250 according to a comparative example having the configuration disclosed in Japanese Unexamined Patent Publication No. 2019-46876. The electronic component 250 includes the capacitor portions 10A and 10B in the stacking direction. In the electronic component 250, it is possible to detect the short-circuiting of each of the capacitor portions 10A and 10B. However, since the interlayer distance is short, there is a possibility that both the capacitor portions 10A and 10B will be short-circuited when the bending crack CR occurs.

FIG. 7B is a schematic cross-sectional view showing an electronic component 150 according to a comparative example. In the electronic component 150, the third internal electrode 13 and the fourth internal electrode 14 are not formed on the same plane, and the first internal electrode 11 and the second internal electrode 12 are not formed on the same plane. In the second capacitor portion 10B, the fourth internal electrode is the outermost layer. Since the internal electrodes 15 and 16 are not provided, the external connection conductor 6 is not separated unlike the external connection conductors 6A, 6B, but has a configuration in which the external connection conductors 6A and 6B are connected to each other. In this case, in the second capacitor portion 10B, surface leakage may occur between the fourth internal electrode (positive electrode) of the outermost layer and the second terminal electrode 4 (negative electrode) having an opposite polarity. In addition, the external connection conductor 6 extends over the entire area in the Y-axis direction on the first main surface 2a. In this case, during mounting, the external connection conductor 6 obstructs the first main surface 2a from being attracted by a tool. In addition, if the external connection conductor 6 becomes largely unbalanced, the electronic component 100 may have a posture perpendicular to the X-axis direction relative to the substrate (chip standing). In addition, the ESL of the external connection conductor 6 increases.

In contrast, in the electronic component 100 according to the present embodiment, the first internal electrode 11 connected to the first terminal electrode 3 faces the internal electrodes 13 and 15, and the second internal electrode 12 connected to the second terminal electrode 4 faces the internal electrodes 14 and 16. Here, the third internal electrode 13 and the sixth internal electrode 16 are electrically connected to each other through the first external connection conductor 6A formed on the first side surface 2e. The fourth internal electrode 14 and the fifth internal electrode 15 are electrically connected to each other through the second external connection conductor 6B formed on the second side surface 2f. With such a configuration, the first capacitor portion 10A formed by the first internal electrode 11 and the third internal electrode 13 facing each other and the second capacitor portion 10B formed by the second internal electrode 12 and the sixth internal electrode 16 facing each other are connected in series through the first external connection conductor 6A. In addition, the third capacitor portion 10C formed by the first internal electrode 11 and the fifth internal electrode 15 facing each other and the fourth capacitor portion 10D formed by the second internal electrode 12 and the fourth internal electrode 14 facing each other are connected in series through the second external connection conductor 6B. Therefore, it is possible to improve the reliability. For example, as shown in FIG. 8A, even if the crack CR occurs in the capacitor portions 10A and 10C to cause short-circuiting, the capacitor portions 10B and 10D can continue to be used. In addition, the presence or absence of short-circuit failure in the capacitor portions 10A and 10C can be measured and inspected by using the first terminal electrode 3 and the external connection conductors 6A and 6B, and the presence or absence of short-circuit failure in the capacitor portions 10B and 10D can be measured and inspected by using the second terminal electrode 4 and the external connection conductors 6A and 6B.

In addition, the second internal electrode 12 is separated from the first internal electrode 11, the fourth internal electrode 14 is separated from the third internal electrode 13, and the sixth internal electrode 16 is separated from the fifth internal electrode 15. That is, between the capacitor portions 10A and 10C on one side in the X-axis direction and the capacitor portions 10B and 10D on the other side in the X-axis direction, there is no connection portion (see FIG. 8C) for connecting their internal electrodes to each other. Therefore, as shown in FIG. 8B, it is possible to suppress the occurrence of a situation in which the crack CR generated in the capacitor portions 10A and 10C on one side reaches the capacitor portions 10B and 10D on the other side along the connection portion CT. As a result, it is possible to suppress the occurrence of a situation in which the crack CR reaches the capacitor portions 10A and 10C and the capacitor portions 10B and 10D on both sides to cause short-circuiting.

Here, the first internal electrode 11 and the second internal electrode 12 are arranged in the outermost layers of the stacked internal electrodes. In this case, as shown in FIG. 7A, the internal electrode closest to the first terminal electrode 3 on each main surface is the first internal electrode 11 having the same polarity as the first terminal electrode 3, and the internal electrode closest to the second terminal electrode 4 is the second internal electrode 12 having the same polarity as the second terminal electrode 4. Therefore, it is possible to suppress surface leakage between the internal electrode of the outermost layer and the terminal electrode having an opposite polarity. As described above, it is possible to improve the performance of an electronic component having a plurality of capacitor portions connected in series to each other.

In addition, the ESL path of the electronic component 100 according to the present embodiment can be a path shown in FIGS. 6A and 6B. In order to connect the first capacitor portion 10A and the second capacitor portion 10B in series to each other, it is only necessary to add a small path for the first external connection conductor 6A. In order to connect the third capacitor portion 10C and the fourth capacitor portion 10D in series to each other, it is only necessary to add a small path for the second external connection conductor 6B. Therefore, it is possible to reduce the possibility that the ESL of the electronic component 100 will increase.

The external connection conductor 6 extends to the first side surface 2e and the second side surface 2f, and on the first main surface 2a and the second main surface 2b, the ends 6a and 6b of the first external connection conductor 6A and the ends 6a and 6b of the second external connection conductor 6B may be spaced apart from each other in the Y-axis direction. In this case, exposed portions 46 and 46 (see FIG. 2A) that are exposed to the external connection conductors 6A and 6B are formed on the first main surface 2a and the second main surface 2b. Therefore, during mounting, the electronic component 100 can be transported by sucking the exposed portions 46 and 46 on both the main surfaces 2a and 2b with a tool. In addition, during mounting, the occurrence of a situation in which the electronic component 100 has a posture perpendicular to the X-axis direction relative to the substrate (chip standing) is suppressed. In addition, since an increase in the lengths of the external connection conductors 6A and 6B is suppressed, an increase in the ESL can be suppressed.

When viewed from the Z-axis direction, the element body 2 may have a gap portion 25 in which no internal electrode is formed. In this case, it is possible to suppress the progress of a crack generated in the capacitor portions 10A and 10C on one side to the capacitor portions 10B and 10D on the other side.

The width of the gap portion 25 in the X-axis direction may be equal to or greater than the interlayer thickness of the element body 2. In this case, in the gap portion 25, it is possible to secure pressure resistance higher than the voltage breakdown between the layers. In addition, the width of the gap portion 25 in the X-axis direction is not particularly limited, and may be any size. For example, the width of the gap portion 25 in the X-axis direction may be 1% or more of the size of the element body 2 in the Y-axis direction.

The first terminal electrode 3 and the second terminal electrode 4 may include a conductive resin layer. In this case, the reliability of the electronic component 100 can be improved due to the effect of reducing the influence of the stress caused by the bending of the mounting board.

The edge portion 21a of the third internal electrode 13 and the edge portion 23a of the fourth internal electrode 14 that face each other in the X-axis direction and the edge portion 26a of the fifth internal electrode 15 and the edge portion 28a of the sixth internal electrode 16 that face each other in the X-axis direction may be inclined with respect to the Y-axis direction. In this case, the lengths of the first external connection conductor 6A and the second external connection conductor 6B in the X-axis direction can be reduced. In this case, it is possible to reduce the risk of short-circuiting due to the first terminal electrode 3 or the second terminal electrode 4 and the first external connection conductor 6A or the second external connection conductor 6B being electrically connected to each other by solder during mounting on the board.

A layer having the first internal electrode 11 and the second internal electrode 12 is referred to as the first electrode layer 41, a layer having the third internal electrode 13 and the fourth internal electrode 14 is referred to as the second electrode layer 42, and a layer having the fifth internal electrode 15 and the sixth internal electrode 16 is referred to as the third electrode layer 43. In this case, as shown in FIG. 5A, in the element body 2, a plurality of first electrode layers 41, a plurality of second electrode layers 42, and a plurality of third electrode layers 43 may be stacked, and the second electrode layer 42 and the third electrode layer 43 may be stacked alternately with the first electrode layer 41 interposed therebetween. In this case, it is possible to reduce the possibility that the ESL will increase. Specifically, in the lead-out portion 22 where the third internal electrode 13 is connected to the first external connection conductor 6A and the lead-out portion 29 where the sixth internal electrode 16 is connected to the first external connection conductor 6A, the directions of currents flowing therethrough are approximately opposite to each other. Therefore, since the generated magnetic fluxes cancel each other out, the inductance may decrease (the same applies to the internal electrodes 14 and 15). According to the structure shown in FIG. 5A, since the third internal electrode 13 and the sixth internal electrode 16 are stacked with the first electrode layer 41 interposed therebetween, it is possible to reduce the ESL compared to the structure shown in FIG. 5B.

In addition, as shown in FIG. 5B, in the element body 2, a plurality of first electrode layers 41, a plurality of second electrode layers 42, and a plurality of third electrode layers 43 may be stacked, the plurality of second electrode layers 42 may be stacked on the first main surface 2a side with the first electrode layer 41 interposed therebetween, and the plurality of third electrode layers 43 may be stacked on the other second main surface 2b side with the first electrode layer 41 interposed therebetween. In this case, it is possible to suppress an increase in the risk of failure in the lead-out portion 22 connecting the third internal electrode 13 and the first external connection conductor 6A to each other, the lead-out portion 29 connecting the sixth internal electrode 16 and the first external connection conductor 6A to each other, the lead-out portion 24 connecting the fourth internal electrode 14 and the second external connection conductor 6B to each other, and the lead-out portion 27 connecting the fifth internal electrode 15 and the second external connection conductor 6B to each other. Specifically, the directions of currents flowing through the lead-out portion 22 of the third internal electrode 13 and the lead-out portion 29 of the sixth internal electrode 16 are approximately opposite to each other. Therefore, for example, there is a possibility that the electric field intensity of a portion of the edge portion 21a of the third internal electrode 13, which overlaps the lead-out portion 29 connecting the sixth internal electrode 16 and the first external connection conductor 6A to each other, will increase. According to the structure shown in FIG. 5B, it is possible to reduce such a portion compared to the structure shown in FIG. 5A.

The present disclosure is not limited to the embodiment described above.

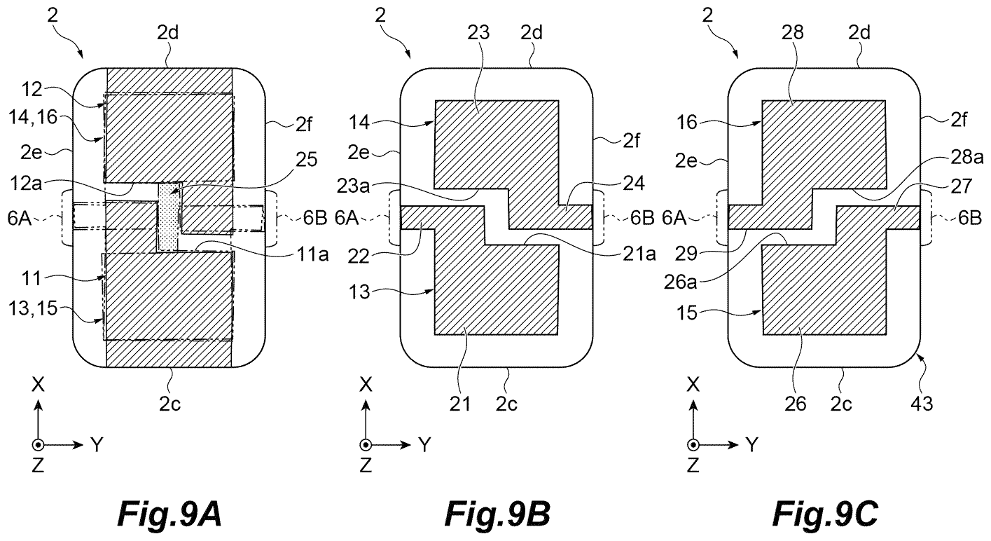

The shape of the internal electrode is not limited to those in the above-described embodiment. For example, structures shown in FIGS. 9A to 9C may be adopted. In the examples shown in FIGS. 9A to 9C, the edge portion 11a of the first internal electrode 11 and the edge portion 12a of the second internal electrode 12, the edge portion 21a of the third internal electrode 13 and the edge portion 23a of the fourth internal electrode 14, and the edge portion 26a of the fifth internal electrode 15 and the edge portion 28a of the sixth internal electrode 16 may be bent in an L shape. The edge portion 11a of the first internal electrode 11 and the edge portion 21a of the third internal electrode 13 are bent so that their regions on the negative side in the Y-axis direction protrude toward the positive side in the X-axis direction (see FIGS. 9A and 9B). The edge portion 26a of the fifth internal electrode 15 is bent so that its region on the positive side in the Y-axis direction protrudes toward the positive side in the X-axis direction (see FIG. 9C). The edge portion 12a of the second internal electrode 12 and the edge portion 23a of the fourth internal electrode 14 are bent so that their regions on the positive side in the Y-axis direction protrude toward the negative side in the X-axis direction (see FIGS. 9A and 9B). The edge portion 28a of the sixth internal electrode 16 is bent so that its region on the negative side in the Y-axis direction protrudes toward the negative side in the X-axis direction (see FIG. 9C). At this time, as shown in FIG. 9A, when viewed from the Z-axis direction, the element body 2 has a gap portion 25, in which the internal electrodes 11, 12, 13, 14, 15, and 16 are not formed, at its center. In addition, in FIG. 9A, a dot pattern is given to the area corresponding to the gap portion 25. According to the configurations shown in FIGS. 9A to 9C, since the overlapping area of the internal electrodes can be increased, it is possible to increase the capacitance.

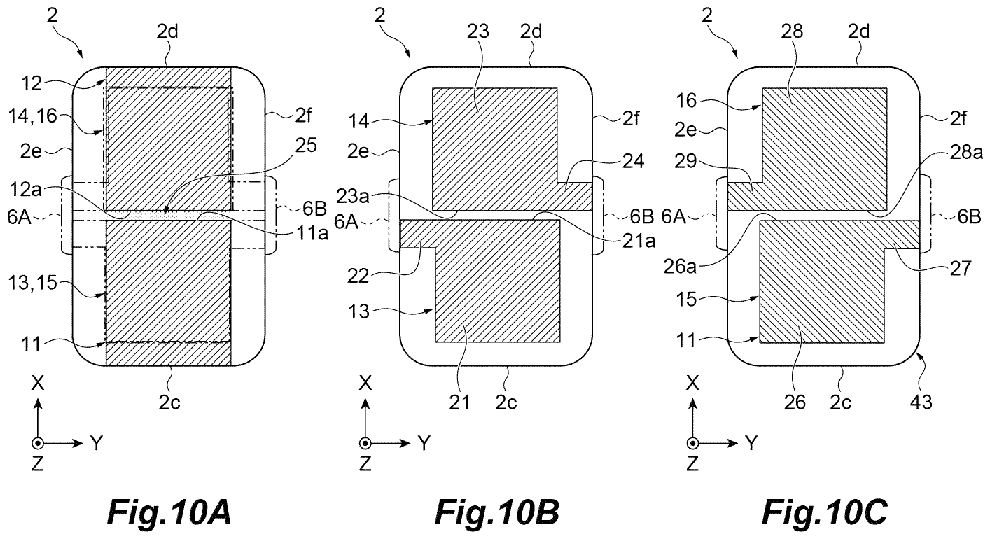

The shape of the internal electrode is not limited to those in the above-described embodiment. For example, structures shown in FIGS. 10A to 10C may be adopted. In the examples shown in FIGS. 10A to 10C, the edge portion 11a of the first internal electrode 11 and the edge portion 12a of the second internal electrode 12, the edge portion 21a of the third internal electrode 13 and the edge portion 23a of the fourth internal electrode 14, and the edge portion 26a of the fifth internal electrode 15 and the edge portion 28a of the sixth internal electrode 16 extend in parallel to the Y-axis direction. At this time, as shown in FIG. 10A, when viewed from the Z-axis direction, the element body 2 has a gap portion 25 in which the internal electrodes 11, 12, 13, 14, 15, and 16 are not formed. The gap portion 25 is formed at the center position of the element body 2 in the X-axis direction so as to extend in the Y-axis direction. According to the configurations shown in FIGS. 10A to 10C, the overlapping structure of the internal electrodes can be made simple.

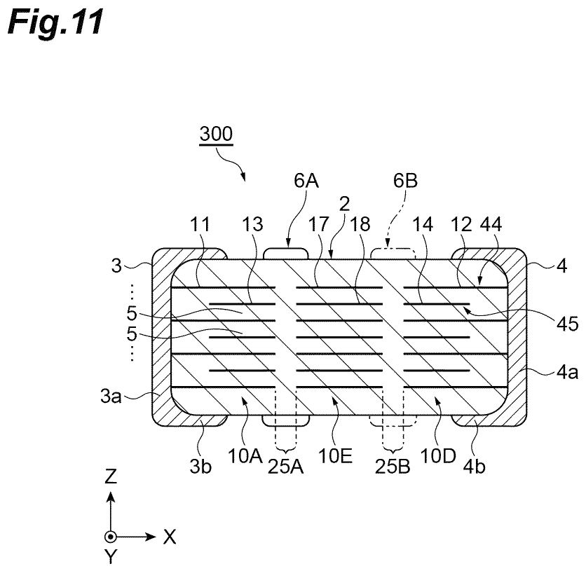

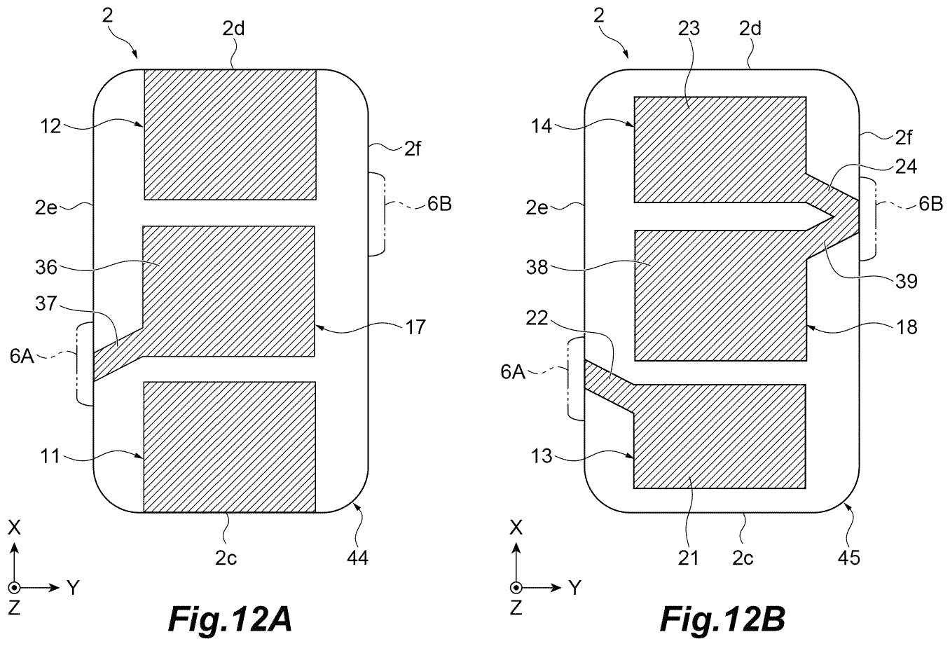

In addition, an electronic component 300 shown in FIG. 11 may be adopted. The electronic component 300 has a seventh internal electrode 17 and an eighth internal electrode 18 between the internal electrodes 11 and 13 and between the internal electrodes 12 and 14, respectively. The seventh internal electrode 17 is formed in the same plane as the internal electrodes 11 and 12 (see FIG. 12A). The seventh internal electrode 17 is mechanically separated (spaced apart) from the internal electrodes 11 and 12. The eighth internal electrode 18 is formed in the same plane as the internal electrodes 13 and 14 (see FIG. 12B). The eighth internal electrode 18 is mechanically separated (spaced apart) from the internal electrode 13. The eighth internal electrode 18 is mechanically separated (spaced apart) from the internal electrode 14 in areas other than lead-out portions 24 and 39 described below.

As shown in FIG. 12A, the seventh internal electrode 17 has a main body portion 36 and a lead-out portion 37 that is led out to the first side surface 2e. As shown in FIG. 12B, the eighth internal electrode 18 has a main body portion 38 and a lead-out portion 39 that is led out to the second side surface 2f. The main body portion 36 of the seventh internal electrode 17 and the main body portion 38 of the eighth internal electrode 18 face each other in the Z-axis direction, but do not face other internal electrodes. The lead-out portion 22 of the third internal electrode 13 and the lead-out portion 37 of the seventh internal electrode 17 are connected to each other through the first external connection conductor 6A. The lead-out portion 24 of the fourth internal electrode 14 and the lead-out portion 39 of the eighth internal electrode 18 are joined and connected to each other, and connected to the second external connection conductor 6B.

As a result, as shown in FIG. 11, the first capacitor portion 10A formed by the first internal electrode 11 and the third internal electrode 13 facing each other and the fifth capacitor portion 10E formed by the seventh internal electrode 17 and the eighth internal electrode 18 facing each other are connected in series through the first external connection conductor 6A, and the fifth capacitor portion 10E formed by the seventh internal electrode 17 and the eighth internal electrode 18 facing each other and the fourth capacitor portion 10D formed by the second internal electrode 12 and the fourth internal electrode 14 facing each other are connected in series through the second external connection conductor 6B.

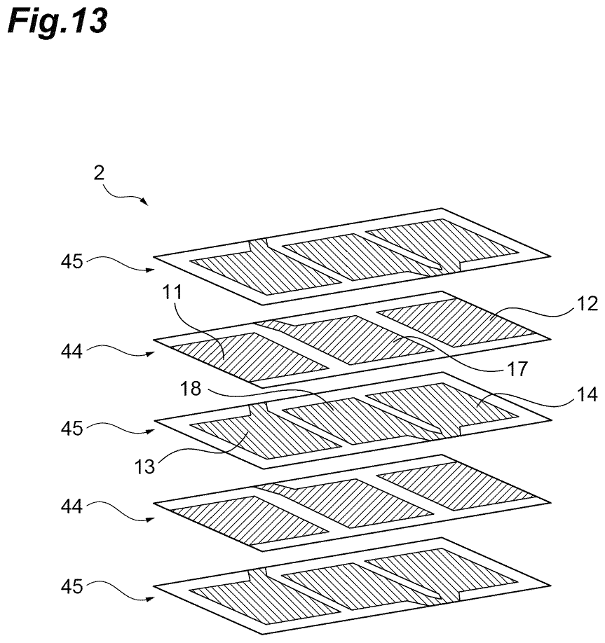

A layer having the first internal electrode 11, the second internal electrode 12, and the seventh internal electrode 17 is referred to as a fourth electrode layer 44. A layer having the third internal electrode 13, the fourth internal electrode 14, and the eighth internal electrode 18 is referred to as a fifth electrode layer 45. The stacking order of the fourth electrode layer 44 and the fifth electrode layer 45 is not particularly limited. For example, the order shown in FIG. 13 may be adopted. As shown in FIG. 13, in the element body 2, the fifth electrode layer 45 is provided above and below the fourth electrode layer 44. That is, the fifth electrode layer 45, the fourth electrode layer 44, and the fifth electrode layer 45 are stacked in this order from the bottom, and this stacking order is repeated.

As described above, in the electronic component 300, the first internal electrode 11 connected to the first terminal electrode 3 faces the third internal electrode 13, the second internal electrode 12 connected to the second terminal electrode 4 faces the fourth internal electrode 14, and the seventh internal electrode 17 faces the eighth internal electrode 18. Here, the third internal electrode 13 and the seventh internal electrode 17 are electrically connected to each other through the first external connection conductor 6A formed on the first side surface 2e. In addition, the fourth internal electrode 14 and the eighth internal electrode 18 are electrically connected to each other through the second external connection conductor 6B formed on the second side surface 2f. With such a configuration, the first capacitor portion 10A formed by the first internal electrode 11 and the third internal electrode 13, the fifth capacitor portion 10E formed by the seventh internal electrode 17 and the eighth internal electrode 18, and the fourth capacitor portion 10D formed by the second internal electrode 12 and the fourth internal electrode 14 are connected in series through the first external connection conductors 6A and 6B, so that it is possible to improve the reliability. In addition, the seventh internal electrode 17 is separated from the first internal electrode 11 and the second internal electrode 12. The eighth internal electrode 18 is separated from the third internal electrode 13 and the fourth internal electrode 14. That is, between the capacitor portions 10A and 10E adjacent to each other and between the capacitor portions 10E and 10D adjacent to each other, there is no connection portion CT for connecting their internal electrodes to each other. For this reason, it is possible to suppress the occurrence of a situation in which a crack generated in one capacitor portion reaches the other capacitor portion along the connection portion CT. As a result, it is possible to suppress the occurrence of a situation in which the crack reaches both the capacitor portions 10A and 10E adjacent to each other and both the capacitor portions 10E and 10D adjacent to each other to cause short-circuiting. As described above, it is possible to improve the performance of the electronic component 300 having a plurality of capacitor portions connected in series to each other.

The shape of the element body 2 is not limited to a rectangular parallelepiped shape as long as the shape has a pair of main surfaces facing each other and side surfaces extending between the main surfaces.

### [Form 1]

An electronic component, including:
an element body having a first main surface and a second main surface facing each other in a first direction, a first end surface and a second end surface facing each other in a second direction perpendicular to the first direction, and a first side surface and a second side surface facing each other in a third direction perpendicular to the first and second directions;
a first terminal electrode formed on the first end surface;
a second terminal electrode formed on the second end surface;
a first external connection conductor formed on the first side surface;
a second external connection conductor formed on the second side surface and separated from the first external connection conductor;
a first internal electrode provided in the element body and connected to the first terminal electrode at the first end surface;
a second internal electrode provided in the element body, separated from the first internal electrode, and connected to the second terminal electrode at the second end surface;
a third internal electrode provided in the element body, facing the first internal electrode in the first direction, and connected to the first external connection conductor at the first side surface;
a fourth internal electrode provided in the element body, facing the second internal electrode in the first direction, separated from the third internal electrode, and connected to the second external connection conductor at the second side surface;
a fifth internal electrode provided in the element body, facing the first internal electrode in the first direction, and connected to the second external connection conductor at the second side surface; and
a sixth internal electrode provided in the element body, facing the second internal electrode in the first direction, separated from the fifth internal electrode, and connected to the first external connection conductor at the first side surface,
wherein a first capacitor portion formed by the first internal electrode and the third internal electrode facing each other and a second capacitor portion formed by the second internal electrode and the sixth internal electrode facing each other are connected in series through the first external connection conductor, and
a third capacitor portion formed by the first internal electrode and the fifth internal electrode facing each other and a fourth capacitor portion formed by the second internal electrode and the fourth internal electrode facing each other are connected in series through the second external connection conductor.

### [Form 2]

The electronic component according to Form 1,
wherein the first internal electrode and the second internal electrode are arranged in outermost layers of stacked internal electrodes.

### [Form 3]

The electronic component according to Form 1 or 2,
wherein the element body has a gap portion in which no internal electrode is formed when viewed from the first direction.

### [Form 4]

The electronic component according to Form 3,
wherein a width of the gap portion in the second direction is equal to or greater than an interlayer thickness of the element body.

### [Form 5]

The electronic component according to any one of Forms 1 to 4,
wherein the first terminal electrode and the second terminal electrode include a conductive resin layer.

### [Form 6]

The electronic component according to any one of Forms 1 to 5,
wherein an edge portion of the third internal electrode and an edge portion of the fourth internal electrode facing each other in the second direction and an edge portion of the fifth internal electrode and an edge portion of the sixth internal electrode facing each other in the second direction are bent in an L shape or inclined with respect to the third direction.

### [Form 7]

The electronic component according to any one of Forms 1 to 6,
wherein, assuming that a layer having the first internal electrode and the second internal electrode is a first electrode layer, a layer having the third internal electrode and the fourth internal electrode is a second electrode layer, and a layer having the fifth internal electrode and the sixth internal electrode is a third electrode layer, a plurality of the first electrode layers, a plurality of the second electrode layers, and a plurality of the third electrode layers are stacked in the element body, and the second electrode layer and the third electrode layer are stacked alternately with the first electrode layer interposed between the second electrode layer and the third electrode layer.

### [Form 8]

The electronic component according to any one of Forms 1 to 7,
wherein, assuming that a layer having the first internal electrode and the second internal electrode is a first electrode layer, a layer having the third internal electrode and the fourth internal electrode is a second electrode layer, and a layer having the fifth internal electrode and the sixth internal electrode is a third electrode layer, a plurality of the first electrode layers, a plurality of the second electrode layers, and a plurality of the third electrode layers are stacked in the element body, the plurality of second electrode layers are stacked on one main surface side of the first main surface and the second main surface with the first electrode layer interposed between the plurality of second electrode layers, and the plurality of third electrode layers are stacked on the other main surface side of the first main surface and the second main surface with the first electrode layer interposed between the plurality of third electrode layers.

### [Form 9]

An electronic component, including:
an element body having a first main surface and a second main surface facing each other in a first direction, a first end surface and a second end surface facing each other in a second direction perpendicular to the first direction, and a first side surface and a second side surface facing each other in a third direction perpendicular to the first and second directions;
a first terminal electrode formed on the first end surface;
a second terminal electrode formed on the second end surface;
a first external connection conductor formed on the first side surface;
a second external connection conductor formed on the second side surface and separated from the first external connection conductor;
a first internal electrode provided in the element body and connected to the first terminal electrode at the first end surface;
a second internal electrode provided in the element body, separated from the first internal electrode, and connected to the second terminal electrode at the second end surface;
a third internal electrode provided in the element body, facing the first internal electrode in the first direction, and connected to the first external connection conductor at the first side surface;
a fourth internal electrode provided in the element body, facing the second internal electrode in the first direction, separated from the third internal electrode, and connected to the second external connection conductor at the second side surface;
a seventh internal electrode provided in the element body, arranged between the first internal electrode and the second internal electrode in the second direction, separated from the first internal electrode and the second internal electrode, and connected to the first external connection conductor at the first side surface; and
an eighth internal electrode provided in the element body, arranged between the third internal electrode and the fourth internal electrode in the second direction, separated from the third internal electrode and the fourth internal electrode, and connected to the second external connection conductor at the second side surface,
wherein a first capacitor portion formed by the first internal electrode and the third internal electrode facing each other and a fifth capacitor portion formed by the seventh internal electrode and the eighth internal electrode facing each other are connected in series through the first external connection conductor, and
a fifth capacitor portion formed by the seventh internal electrode and the eighth internal electrode facing each other and a fourth capacitor portion formed by the second internal electrode and the fourth internal electrode facing each other are connected in series through a second external connection conductor.

### REFERENCE SIGNS LIST

2: element body, 2a: first main surface, 2b: second main surface, 2c: first end surface, 2d: second end surface, 2e: first side surface, 2f: second side surface, 3: first terminal electrode, 4: second terminal electrode, 6A: first external connection conductor, 6B: second external connection conductor, 10A: first capacitor portion, 10B: second capacitor portion, 10C: third capacitor portion, 10D: fourth capacitor portion, 10E: fifth capacitor portion, 11: first internal electrode, 12: second internal electrode, 13: third internal electrode, 14: fourth internal electrode, 15: fifth internal electrode, 16: sixth internal electrode, 17: seventh internal electrode, 18: eighth internal electrode, 41: first electrode layer, 42: second electrode layer, 43: third electrode layer, 100, 300: electronic component.

What is claimed is:

1. An electronic component, comprising:
an element body having a first main surface and a second main surface facing each other in a first direction, a first end surface and a second end surface facing each other in a second direction perpendicular to the first direction, and a first side surface and a second side surface facing each other in a third direction perpendicular to the first and second directions;
a first terminal electrode formed on the first end surface;
a second terminal electrode formed on the second end surface;
a first external connection conductor formed on the first side surface;
a second external connection conductor formed on the second side surface and separated from the first external connection conductor;
a first internal electrode provided in the element body and connected to the first terminal electrode at the first end surface;
a second internal electrode provided in the element body, separated from the first internal electrode, and connected to the second terminal electrode at the second end surface;
a third internal electrode provided in the element body, facing the first internal electrode in the first direction, and connected to the first external connection conductor at the first side surface;
a fourth internal electrode provided in the element body, facing the second internal electrode in the first direction, separated from the third internal electrode, and connected to the second external connection conductor at the second side surface;
a fifth internal electrode provided in the element body, facing the first internal electrode in the first direction, and connected to the second external connection conductor at the second side surface; and
a sixth internal electrode provided in the element body, facing the second internal electrode in the first direction, separated from the fifth internal electrode, and connected to the first external connection conductor at the first side surface,
wherein a first capacitor portion formed by the first internal electrode and the third internal electrode facing each other and a second capacitor portion formed by the second internal electrode and the sixth internal electrode facing each other are connected in series through the first external connection conductor, and
a third capacitor portion formed by the first internal electrode and the fifth internal electrode facing each other and a fourth capacitor portion formed by the second internal electrode and the fourth internal electrode facing each other are connected in series through the second external connection conductor.

2. The electronic component according to claim 1,
wherein the first internal electrode and the second internal electrode are arranged in outermost layers of stacked internal electrodes.

3. The electronic component according to claim 1,
wherein the element body has a gap portion in which no internal electrode is formed when viewed from the first direction.

4. The electronic component according to claim 3,
wherein a width of the gap portion in the second direction is equal to or greater than an interlayer thickness of the element body.

5. The electronic component according to claim 1,
wherein the first terminal electrode and the second terminal electrode include a conductive resin layer.

6. The electronic component according to claim 1,
wherein an edge portion of the third internal electrode and an edge portion of the fourth internal electrode facing each other in the second direction and an edge portion of the fifth internal electrode and an edge portion of the sixth internal electrode facing each other in the second direction are bent in an L shape or inclined with respect to the third direction.

7. The electronic component according to claim 1,
wherein, assuming that a layer having the first internal electrode and the second internal electrode is a first electrode layer, a layer having the third internal electrode and the fourth internal electrode is a second electrode layer, and a layer having the fifth internal electrode and the sixth internal electrode is a third electrode layer, a plurality of the first electrode layers, a plurality of the second electrode layers, and a plurality of the third electrode layers are stacked in the element body, and the second electrode layer and the third electrode layer are stacked alternately with the first electrode layer interposed between the second electrode layer and the third electrode layer.

8. The electronic component according to claim 1,
wherein, assuming that a layer having the first internal electrode and the second internal electrode is a first electrode layer, a layer having the third internal electrode and the fourth internal electrode is a second electrode layer, and a layer having the fifth internal electrode and the sixth internal electrode is a third electrode layer, a plurality of the first electrode layers, a plurality of the second electrode layers, and a plurality of the third electrode layers are stacked in the element body, the plurality of second electrode layers are stacked on one main surface side of the first main surface and the second main surface with the first electrode layer interposed between the plurality of second electrode layers, and the plurality of third electrode layers are stacked on the other main surface side of the first main surface and the second main surface with the first electrode layer interposed between the plurality of third electrode layers.

9. An electronic component, comprising:
an element body having a first main surface and a second main surface facing each other in a first direction, a first end surface and a second end surface facing each other in a second direction perpendicular to the first direction, and a first side surface and a second side surface facing each other in a third direction perpendicular to the first and second directions;
a first terminal electrode formed on the first end surface;
a second terminal electrode formed on the second end surface;
a first external connection conductor formed on the first side surface;
a second external connection conductor formed on the second side surface and separated from the first external connection conductor;
a first internal electrode provided in the element body and connected to the first terminal electrode at the first end surface;
a second internal electrode provided in the element body, separated from the first internal electrode, and connected to the second terminal electrode at the second end surface;
a third internal electrode provided in the element body, facing the first internal electrode in the first direction, and connected to the first external connection conductor at the first side surface;
a fourth internal electrode provided in the element body, facing the second internal electrode in the first direction, separated from the third internal electrode, and connected to the second external connection conductor at the second side surface;
a seventh internal electrode provided in the element body, arranged between the first internal electrode and the second internal electrode in the second direction, separated from the first internal electrode and the second internal electrode, and connected to the first external connection conductor at the first side surface; and
an eighth internal electrode provided in the element body, arranged between the third internal electrode and the fourth internal electrode in the second direction, separated from the third internal electrode and the fourth internal electrode, and connected to the second external connection conductor at the second side surface,
wherein a first capacitor portion formed by the first internal electrode and the third internal electrode facing each other and a fifth capacitor portion formed by the seventh internal electrode and the eighth internal electrode facing each other are connected in series through the first external connection conductor, and
a fifth capacitor portion formed by the seventh internal electrode and the eighth internal electrode facing each other and a fourth capacitor portion formed by the second internal electrode and the fourth internal electrode facing each other are connected in series through a second external connection conductor.
